(19) United States
(12) Patent Application Publication
(10) Pub. No.: US 2026/0078754 A1
(43) Pub. Date: Mar. 19, 2026

(54) SYSTEMS, ASSEMBLIES, APPARATUSES, AND METHODS PROVIDING ENHANCED FLUID SEAL FOR HIGH-POWER PUMPS

(71) Applicant: Vulcan Industrial Holdings, LLC, Houston, TX (US)

(72) Inventors: Neerav Verma, Houston, TX (US); Benjamin Scott Berryhill, Houston, TX (US); Richard David Peer, Houston, TX (US)

(21) Appl. No.: 19/327,011

(22) Filed: Sep. 12, 2025

Related U.S. Application Data
(60) Provisional application No. 63/694,532, filed on Sep. 13, 2024.

(51) Int. Cl. F04B 53/16; F16J 15/18

(52) U.S. Cl. CPC F04B 53/164; F16J 15/183

(57) ABSTRACT

Systems, assemblies, apparatuses, and methods herein may provide an enhanced fluid seal between two components. A seal to enhance a fluid seal between a surface of a first component of a pump and a surface of a second component of the pump may include an annular seal body having a seal body surface and a seal cross-section at least partially defined by the seal body surface. The annular seal body may include a metal mesh, thereby to enhance thermal conductivity between the seal and one or more of the first component or the second component, so as to transfer heat from the seal to one or more of the first component or the second component, thereby to reduce a temperature of the seal and extend a service life of the seal.

### CROSS REFERENCE TO RELATED APPLICATIONS

This application claims priority to, and the benefit of U.S. Provisional Application No. 63/694,532, filed Sep. 13, 2024, titled “SYSTEMS, ASSEMBLIES, APPARATUSES, AND METHODS PROVIDING ENHANCED FLUID SEAL FOR HIGH-POWER PUMPS,” the disclosure of which is incorporated herein by reference in its entirety.

### TECHNICAL FIELD

The present disclosure relates to systems, assemblies, apparatuses, and methods providing an enhanced fluid seal for high-power pumps and, more particularly, to systems, assemblies, apparatuses, and methods providing an enhanced fluid seal between components in high-power pumps.

### BACKGROUND

Pumps may be used to transfer a fluid having a first pressure from one location to another location at a second pressure greater than the first pressure. Some types of pumps may be subject to fluctuating interior pressure and elevated temperatures during operation. For example, components of a reciprocating pump may be exposed to fluctuating pressures and elevated temperatures during operation, for example, as plungers reciprocate within a fluid end of the pump.

Pumps may often include a number of fluid seals to prevent fluid from passing from one portion of the pump to another or from the interior of the pump to the exterior of the pump. An example of such a seal may be used to provide a fluid seal between mating components of the pump. For example, some types of pumps may include various ports that receive another component, and it may be important to provide a fluid seal between the port and the other component. For example, in a reciprocating pump, one or more seals may be provided between a plungers of the pump and a fluid end in which the plungers reciprocate. Some types of pumps, as noted above, may experience relatively large fluctuations in pressure and elevated temperatures, for example, during reciprocation of the plungers. Applicant has recognized that this may result in causing seals in the fluid end to degrade relatively more quickly. The degradation may be particularly pronounced, depending on the contents of the fluid. For example, abrasive particles and/or corrosive fluids may accelerate the degradation of the seals, potentially leading to shortened service lives of the seals, as well as increased downtime, reducing the efficiency of operations using the pump.

An example of a high-power pump includes a pump that may be used to pump fracturing fluid at high pressures and high flow rates during a hydraulic fracturing operation. For example, a hydraulic fracturing operation involves pumping a fracturing fluid at high flow rates and high pressures sufficient to fracture a reservoir formation to allow hydrocarbons to more easily flow from the formation toward a wellbore for production. Such high rates of flow and high pressures may result in significant wear to components associated with the fluid flow, such as high-power pumps used to pump the fracturing fluid. In addition, the fracturing fluid may contain substances, for example, proppants and fluids having abrasive and corrosive characteristics, and thus, seals and components associated with operation of the pumps may exhibit relatively higher wear rates or failure rates. As a result, components associated with pumps, such as seals, may be particularly susceptible high wear rates and failure rates, thereby requiring relatively more frequent maintenance, repair, or replacement, which may increase downtime for the hydraulic fracturing operation and reduce efficiency and productivity. For example, the seals and related components may degrade with use in such harsh conditions, as described above, creating leakage at the seals and related components, which reduces the efficiency and capabilities of the pump.

For at least these reasons, Applicant has recognized that it may be desirable to provide seals, related assemblies, and related methods resulting in relatively longer service lives that reduce downtime associated with use in a high-power pump. At least some examples described herein may address one or more of the above-noted potential issues, as well as possibly others.

### SUMMARY

As referenced above, it may be desirable to provide seals, related assemblies, and related methods that result in relatively longer service lives that reduce downtime associated with use in a high-power pump, such as, for example, seals and components used in the oil and gas industry, where the operating conditions and fluids may present a particularly harsh environment. In some embodiments, the systems, assemblies, apparatuses, and methods presented herein may provide a relatively enhanced fluid seal between pump components, such as seals and adjacent components, which may result in relatively reduced damage, deformation, wear, and/or leakage during operation of high-power pumps including the seals and components. For example, in some embodiments, the seals and associated components may be configured to reduce or prevent damage, deformation, wear, and/or leakage of the seals and associated components during operation of a high-power pump.

According to some embodiments, a fluid end for a high pressure pump may include a fluid end block at least partially defining a fluid end bore, and a packing recess associated with the fluid end bore. The packing recess may at least partially define a packing recess bore. The fluid end further may include a packing assembly at least partially received in the packing recess bore. The packing assembly may be positioned to enhance a fluid seal between a surface of a first component of the high pressure pump and a surface of a second component of the high pressure pump. The packing assembly may include a packing assembly seal including an annular seal body having a seal body surface and a seal cross-section at least partially defined by the seal body surface. The annular seal body may include a metal mesh, thereby to enhance thermal conductivity between the packing assembly seal and one or more of the first component or the second component, so as to transfer heat from the packing assembly seal to one or more of the first component or the second component, thereby to reduce a temperature of the packing assembly seal and extend a service life of the packing assembly seal. The fluid end further may include one or more of (a) a lantern ring, (b) a lube seal, (c) an adaptor ring, (d) a pressure ring, or (e) a junk ring.

According to some embodiments, a high pressure pump may include a fluid end as described herein.

According to some embodiments, a packing assembly to enhance a fluid seal between a surface of a first component of a high pressure pump and a surface of a second component of the high pressure pump may include a packing assembly seal including an annular seal body having a seal body surface and a seal cross-section at least partially defined by the seal body surface. The annular seal body may include a metal mesh, thereby to enhance thermal conductivity between the packing assembly seal and one or more of the first component or the second component, so as to transfer heat from the packing assembly seal to one or more of the first component or the second component, thereby to reduce a temperature of the packing assembly seal and extend a service life of the packing assembly seal. The packing assembly further may include one or more of (a) a lantern ring, (b) a lube seal, (c) an adaptor ring, (d) a pressure ring, or (e) a junk ring.

According to some embodiments, a packing assembly to enhance a fluid seal between a surface of a first component of a high pressure pump and a surface of a second component of the high pressure pump may include a header ring. The header ring may include an annular seal body having a seal body surface and a seal cross-section at least partially defined by the seal body surface. The annular seal body may include a metal mesh, thereby to enhance thermal conductivity between the header ring and one or more of the first component or the second component, so as to transfer heat from the header ring to one or more of the first component or the second component, thereby to reduce a temperature of the header ring and extend a service life of the header ring. The packing assembly further may include one or more of (a) a lantern ring, (b) a lube seal, (c) an adaptor ring, (d) a pressure ring, or (e) a junk ring.

According to some embodiments, a seal to enhance a fluid seal between a surface of a first component of a high pressure pump and a surface of a second component of the high pressure pump may include an annular seal body having a seal body surface and a seal cross-section at least partially defined by the seal body surface. The annular seal body may include a metal mesh, thereby to enhance thermal conductivity between the seal and one or more of the first component or the second component, so as to transfer heat from the seal to one or more of the first component or the second component, thereby to reduce a temperature of the seal and extend a service life of the seal.

According to some embodiments, a header ring for a packing assembly may be positioned to enhance a fluid seal between a surface of a first component of a high pressure pump and a surface of a second component of the high pressure pump. The header ring may include an annular seal body having a seal body surface and a seal cross-section at least partially defined by the seal body surface. The annular seal body may include a metal mesh, thereby to enhance thermal conductivity between the header ring and one or more of the first component or the second component, so as to transfer heat from the header ring to one or more of the first component or the second component, thereby to reduce a temperature of the header ring and extend a service life of the header ring.

According to some embodiments, a method for enhancing a seal between a surface of a first component of a high pressure pump and a surface of a second component of the high pressure pump, may include positioning a seal between the surface of the first component and the surface of the second component. The seal may have an annular seal body including a metal mesh. The method further may include transferring heat, via the metal mesh, from the annular seal body to one or more of the first component or the second component during operation of the high pressure pump, thereby to reduce a temperature of the seal and extend a service life of the seal.

According to some embodiments, a method for enhancing a seal between a surface of a first component of a high pressure pump and a surface of a second component of the high pressure pump, may include forming an annular seal body having a seal body surface and a seal cross-section at least partially defined by the seal body surface. The annular seal body may include a metal mesh, thereby to enhance thermal conductivity between the seal and one or more of the first component or the second component, so as to transfer heat from the seal to one or more of the first component or the second component, thereby to reduce a temperature of the seal and extend a service life of the seal.

Still other aspects and advantages of these exemplary embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is a schematic side section view of an example high-power pump and fluid end including example seals between example components of the high-power pump, according to embodiments of the disclosure.

FIG. 2 is a schematic side section view of a portion of the example high-power pump shown in FIG. 1, including an example packing assembly, according to embodiments of the disclosure.

FIG. 3 is a schematic perspective view of an example packing assembly consistent with the example packing assembly shown in FIG. 2, according to embodiments of the disclosure.

FIG. 4A is a schematic cross-section view of an example packing assembly seal, according to embodiments of the disclosure.

FIG. 4B is a schematic cross-section view of yet another example packing assembly seal, according to embodiments of the disclosure.

FIG. 5A is a schematic cross-section view of another example packing assembly seal, according to embodiments of the disclosure.

FIG. 5B is a schematic cross-section view of still another example packing assembly seal, according to embodiments of the disclosure.

FIG. 5C is a schematic cross-section view of yet another example packing assembly seal, according to embodiments of the disclosure.

FIG. 5D is a schematic cross-section view of still a further example packing assembly seal, according to embodiments of the disclosure.

FIG. 5E is a schematic cross-section view of yet a further example packing assembly seal, according to embodiments of the disclosure.

FIG. 6A is a schematic cross-section view of an example packing assembly seal, including an example partial metal mesh cover, according to embodiments of the disclosure.

FIG. 6B is a schematic cross-section view of another example packing assembly seal, including another example partial metal mesh cover, according to embodiments of the disclosure.

FIG. 6C is a schematic cross-section view of still another example packing assembly seal, including still another example partial metal mesh cover, according to embodiments of the disclosure.

FIG. 6D is a schematic cross-section view of yet a further example packing assembly seal, including an example substantially complete metal mesh cover, according to embodiments of the disclosure.

FIG. 7A is a schematic cross-section view of an example packing assembly seal, including metal mesh having an example partial thermally conductive layer, according to embodiments of the disclosure.

FIG. 7B is a schematic cross-section view of another example packing assembly seal, including metal mesh having another example partial thermally conductive layer, according to embodiments of the disclosure.

FIG. 7C is a schematic cross-section view of a further example packing assembly seal, including metal mesh having a further example partial thermally conductive layer, according to embodiments of the disclosure.

FIG. 7D is a schematic cross-section view of a yet another example packing assembly seal, including metal mesh having an example substantially complete thermally conductive layer, according to embodiments of the disclosure.

FIG. 7E is a schematic cross-section view of still another example packing assembly seal, including metal mesh having another example partial thermally conductive layer, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

The present disclosure generally is directed to systems, assemblies, apparatuses, and methods that may provide a relatively enhanced fluid seal between pump components, such as seals and adjacent components, which may result in relatively reduced damage, deformation, wear, and/or leakage during operation of high-power pumps including the seals and components. For example, in some embodiments, the seals and associated components may be configured to reduce or prevent damage, deformation, wear, and/or leakage of the seals and associated components during operation of a high-power pump.

For example, in some embodiments, the seal may have an annular seal body including one or more metal meshes. In some embodiments, the metal mesh associated with the annular seal body may result in enhancing thermal conductivity of the seal. For example, during operation of a pump, a reciprocating motion between a plunger and a seal, such as, for example, a packing assembly seal, may result in development of heat, causing the temperature of the packing assembly seal to increase. In some instances, the increase in temperature may lead to degradation of the packing assembly seal. Applicant has recognized, surprisingly, that by including metal mesh with an annular seal body of a packing assembly seal, the thermal conductivity of the packing assembly seal may be improved. As a result, in at least some embodiments described herein, the packing assembly seal may transfer heat (e.g., dissipate heat) to one or more surrounding components of the pump, thereby to reduce the temperature of the packing assembly seal, so as to reduce the rate of degradation of the packing assembly seal and extend the useful life of the packing assembly seal. Other types of seals are contemplated.

In some embodiments, the seal may include solely one or more metal meshes, for example, and not include other base materials, such as non-metal meshes, rubbers, polymers, and elastomers. In at least some such embodiments, for a pump pumping slurries, such as sand and water, for example, during a hydraulic fracturing operation, pump seals (e.g., packing assembly seals) may be expected to leak liquid during some initial time period. As the pump seals continue to capture solid particles and/or viscous fluid, the particles and/or viscous fluid become entrained in the metal mesh, and the pump seals may function in a manner similar to, for example, a clogged filter. As more particles are entrained by the metal mesh during continued operation of the pump, the pump seal becomes relatively more effective and no longer permits significant leakage.

Without wishing to be bound by theory, it is believed by Applicant that metallic materials, which have relatively higher thermal conductivities as compared with, for example, non-metal meshes, rubbers, polymers, and elastomers, increase the heat transfer to surrounding pump components, facilitating cooling (or reduced heating) of the pump seal. For pump seal embodiments including additional materials, such as non-metal meshes, rubbers, polymers, and elastomers, it is believed by Applicant that the one or more metal meshes may serve to convey heat away from these other non-metallic materials and more efficiently transfer heat to one or more surrounding pump components. This, in turn, may result in reducing the temperature of the seal, so as to reduce degradation of the seal and extend the useful life of the seal. Although packing assembly seals are described in this disclosure, other types of seals are contemplated, including, for example, other types of seals for pumps.

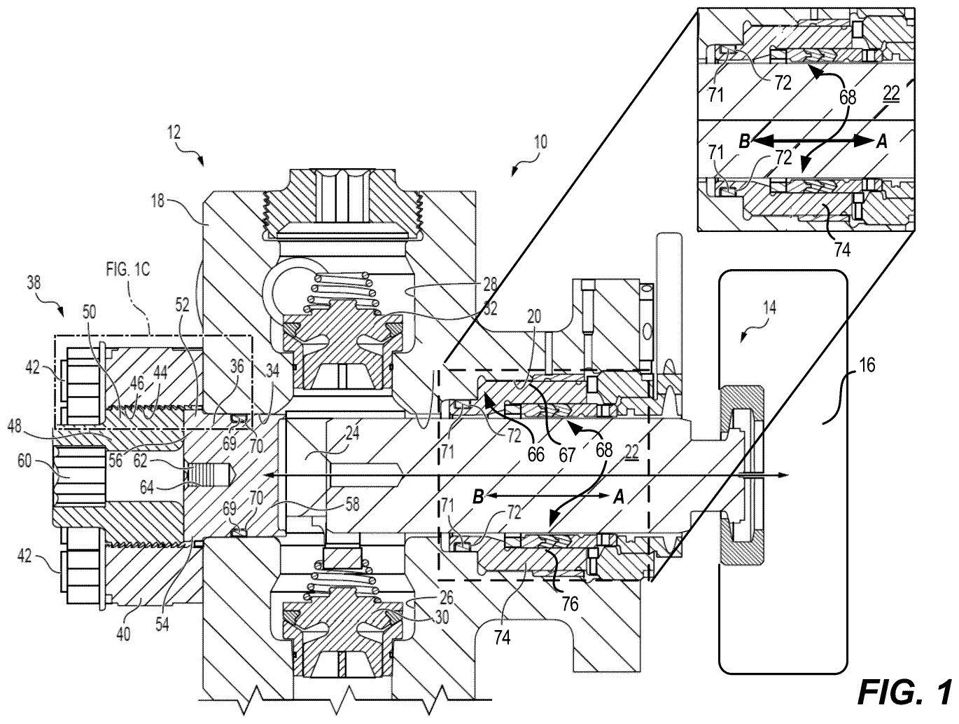

FIG. 1 is a schematic partial side section view of an example pump 10, including an example fluid end assembly 12 and an example power end assembly 14 (only schematically depicted), according to embodiments of the disclosure. In some embodiments, the pump 10 may be, for example, a hydraulic fracturing pump for pumping hydraulic fracturing fluid. Although embodiments of the pump 10 are described herein as being a “hydraulic fracturing pump” for pumping hydraulic fracturing fluid for the purpose of discussion, the pump 10 may be any other type of pump, such as, for example, any type of high-power pump, high-pressure pump, reciprocating pump, and/or high-flow rate pump suitable for pumping solids, semi-solids, slurries, liquids, fluids, or combinations thereof. In some embodiments, the pump 10 may be, for example, a hydraulic fracturing pump for pumping solids, semi-solids, slurries, liquids, fluids, or combinations thereof, such as hydraulic fracturing fluid.

For example, a reciprocating plunger pump may be used to pump a fracturing fluid at high flow rates and high pressures sufficient to fracture a reservoir formation to allow hydrocarbons to more easily flow from the formation toward a wellbore for production. A hydraulic fracturing operation may include as many as six or more hydraulic fracturing units, and each of the hydraulic fracturing units may include a prime mover, such as an electric motor or internal combustion engine, either directly connected, or connected via a transmission, to the reciprocating plunger pump to supply power to drive the reciprocating plunger pump to pump the fracturing fluid into the formation to stimulate production of the well. For example, typical flow rates for a hydraulic fracturing operation may range from about 1,500 to about 4,000 gallons per minute, and typical pressures may range from about 7,500 to about 15,000 pounds per square inch. Although many examples discussed in this disclosure are explained in relation to hydraulic fracturing pumps, such as reciprocating plunger pumps for pumping fracturing fluid and related methods, other flow control-related and/or pumping-related operations, components, and methods are contemplated.

As shown in FIG. 1, the example pump 10 may be a reciprocating plunger pump and may include the fluid end assembly 12 and the power end assembly 14 In some embodiments, the power end assembly 14 may include, for example, a housing 16 with mechanical power transmission components, such as a crankshaft, bearings supporting the crankshaft in the housing, crossheads, reduction gears, and/or connecting rods (e.g., pony rods) and plungers connected to the connecting rods. In some embodiments, the power end assembly 14 may be configured to convert power into reciprocating motion. For example, the power end assembly 14 may be configured to convert rotational power into reciprocating motion, or the power end assembly 14 may be configured to convert electric or hydraulic power into reciprocating motion.

As shown in FIG. 1, the fluid end assembly 12 may include, for example, a fluid end block 18 including one or more fluid end bores 20 (e.g., cylinders) in which respective plungers 22 reciprocate, one or more chambers 24 receiving fluid, one or more suction ports 26 for drawing fluid into the one or more chambers 24, and one or more discharge ports 28 for discharging fluid from the one or more chambers 24 at a higher pressure. For example, as each plunger 22, moved via operation of, for example, a crankshaft and a respective connecting rod of the power end assembly 16, at least partially retracts in direction A into a respective cylinder 20, fluid is drawn into the chamber 24 of the fluid end assembly 12 via the suction port 26 in the fluid end block 18 while an intake valve 30 is open and a discharge valve 32 is closed. As each plunger 22 extends back toward the chamber 24 in direction B, moved via operation of, for example, the crankshaft and the respective connecting rod of the power end assembly 16, pressurized fluid is discharged from the fluid end assembly 12 via the discharge port 28 in the fluid end block 18 while the discharge valve 32 is open and the intake valve 30 is closed. The intake valve 30 and discharge valve 32 may be one-way valves or check valves, allowing fluid to flow only in a single direction, either into the fluid end block 18 via the intake valve 30, or from the fluid end block 18 via the discharge valve 32. In this example manner, the pump 10 draws fluid into the fluid end assembly 12 at a first pressure and discharges the fluid from the fluid end assembly 12 at a higher pressure. In some pump embodiments, the fluid end assembly 12 may include multiple (e.g., two, three, four, or five) sets of intake passages, cylinders, plungers, and discharge passages to pump fluid at high pressures and/or high flow rates. Other types of pumps, fluid end assemblies, and/or power end assemblies are contemplated.

As shown in FIG. 1, in some embodiments, the fluid end assembly 12 may include an access port 34 providing access to the chamber 24, for example, for use during assembly and/or maintenance of the fluid end assembly 12. The access port 34 may be selectively closed via a cover 36 received in the access port 34. In some embodiments, the access port 34 may be defined in the fluid end block 18 by a circular aperture having an interior face having a substantially cylindrical configuration. In some embodiments, the cover 36 may have a substantially circular cross-section and may have a substantially cylindrical configuration sized and shaped to fit within the interior face of the access port 34, for example, as shown in FIG. 1. In some embodiments, the cover 36 may be sized and shaped to fit snugly within the access port 34.

In some embodiments, a retainer assembly 38 may be used to secure the cover 36 within the access port 34. As shown, in some embodiments, the retainer assembly 38 may include an outer housing 40 configured to be secured to an exterior surface of the fluid end block 18 adjacent the access port 34, for example, via one of more fasteners 42. The outer housing 40 may define a receiver aperture 44 provided with interior retainer threads 46. The retainer assembly 38 further may include a retainer 48, which may include a substantially cylindrical body having exterior retainer threads 50 configured to threadedly engage the interior retainer threads 46 of the outer housing 40. In some embodiments, the cover 36 may include a shoulder 52 and a flange 54 having an exterior end 56 opposite an interior end 58 facing the chamber 24. The shoulder 52 and flange 54 may be configured to abut the exterior surface of the fluid end block 18 adjacent the access port 34. The retainer 48 may be threaded into the outer housing 40 and abut the exterior end 56 of the cover assembly 36, thereby to secure the cover assembly 36 in the access port 34. As shown, in some embodiments, the retainer 48 may include a retainer recess 60 configured to be engaged by a tool for assisting the tightening and loosening of the retainer 48 relative to the outer housing 40 and the cover assembly 36.

As shown in FIG. 1, some embodiments of the cover 36 may include a cover recess 62 opening outward from the center of the exterior end 56 of the cover 36 surface and having interior threads 64. The cover recess 62 may be used to assist within removal of the cover 36, for example, to provide access to the chamber 24. For example, a tool may be used to engage the cover recess 62 (e.g., via the interior threads 64) and assist with pulling the cover 36 from the access port 34.

As shown in FIG. 1, in some embodiments, the fluid end block 18 may include a packing recess 66 in the fluid end bore 20 and at least partially defining a packing recess bore 67. In some embodiments, a packing assembly 68 may be received in the packing recess bore 67 of the packing recess 66, thereby to enhance a fluid seal between the packing recess 66 and a plunger 22 reciprocating relative to the fluid end block 18. The packing recess bore 67 of the packing recess 66 and the packing assembly 68 may be substantially cylindrical, with the packing recess 66 having a substantially circular cross-section and the packing assembly 68 having a substantially cylindrical outer surface received in the packing recess 66. The packing assembly 68 may be configured to at least partially receive therein the plunger 22 as the plunger 22 reciprocates, thereby to draw fluid into the chamber 24 at a first pressure via the suction port 26 during movement of the plunger 22 in the first direction A and discharge the fluid from the chamber 24 at a second pressure greater than the first pressure via the discharge port 28 during movement of the plunger 22 in the second direction B, for example, as shown in FIG. 1.

As shown in FIG. 1, an annular seal 69 may be provided between the interior surface of the access port 34 and an exterior surface of the cover 36, thereby to provide a fluid seal between the access port 34 the cover 36 when the cover 36 is received in the access port 34. For example, as shown, the cover 36 may include on the outer cylindrical surface thereof an annular groove 70, and the seal 69 may be at least partially received in the annular groove 70.

As shown in FIG. 1, an annular seal 71 may be provided between the interior surface of the packing recess 66 and an exterior surface of a packing sleeve 74, thereby to provide a fluid seal between the first and second components, for example, the packing recess 66 and the packing sleeve 74, when an end of the packing sleeve 74 is placed in the packing recess 66. For example, as shown, the packing sleeve 74 may include on the outer cylindrical surface thereof an annular groove 72, and the seal 71 may be at least partially received in the annular groove 72.

As shown in FIG. 1, in some embodiments, the packing sleeve 74 may be received in the packing sleeve bore 67 of the fluid end bore 20, and the packing assembly 68 may be received in a packing assembly bore 76 of the packing sleeve 74. The packing assembly 68 may be configured to provide an at least partial fluid seal between the plunger 22 as it reciprocates and the packing sleeve 74, for example, as described herein.

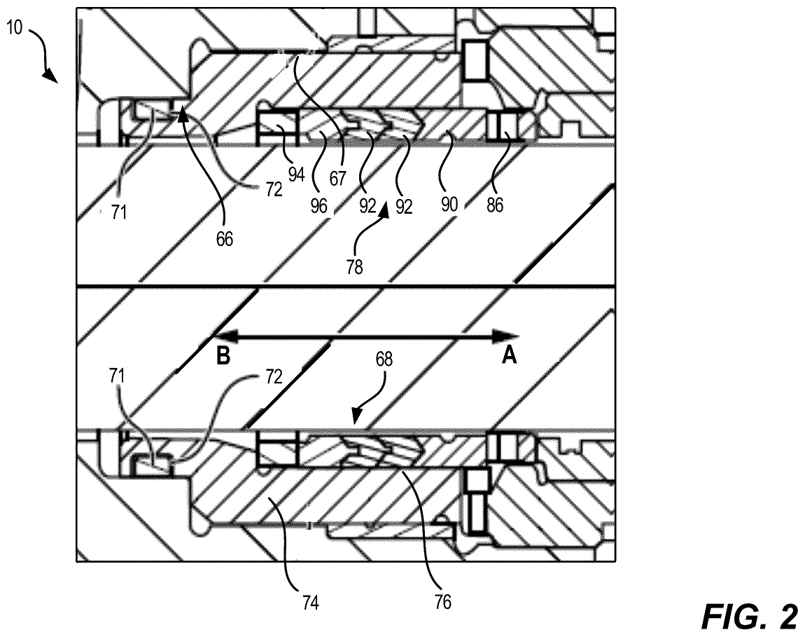

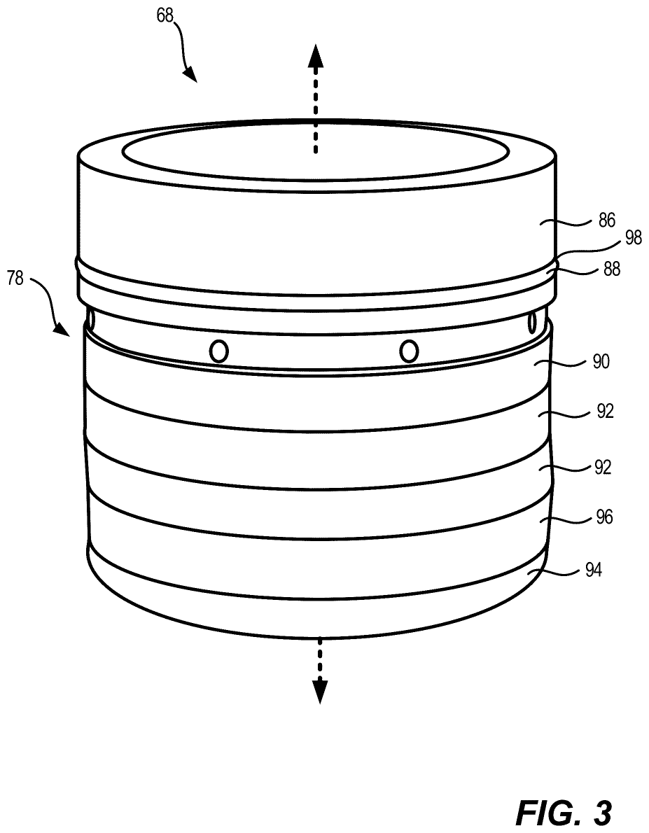

FIG. 2 is a schematic side section view of a portion of the example high-power pump 10 shown in FIG. 1, including the example packing assembly 68, and FIG. 3 is a schematic perspective view of an example packing assembly 68 consistent with the example packing assembly 68 shown in FIG. 2, according to embodiments of the disclosure. As shown in FIGS. 2 and 3, in some embodiments, the packing assembly 68 may be configured to enhance a fluid seal between a surface of a first component of a pump and a surface of a second component of the pump. For example, the packing assembly 68 may include one or more packing assembly seals 78 (e.g., a header ring and/or a scraper ring). The packing assembly seals 78 may include an annular seal body 80 having a seal body surface 82 and a seal cross-section 84 at least partially defined by the seal body surface 82. In at least some embodiments, the annular seal body 80 may include one or more metal meshes 85, thereby to enhance thermal conductivity between the packing assembly seal 78 and one or more of the first component or the second component, so as to transfer heat from the packing assembly seal 78 to one or more of the first component or the second component, thereby to reduce a temperature of the packing assembly seal 78 and extend a service life of the packing assembly seal 78, for example, as described herein. In some embodiments, the metal mesh 85 may include a woven metal mesh, a non-woven metal mesh, a metal woven fabric, and/or a metal non-woven fabric.

In some embodiments, the packing assembly 68 further may include (a) a lantern ring 86, (b) a lube seal 88, (c) an adaptor ring 90, (d) one or more pressure rings 92 and/or (e) a junk ring 94. In some embodiments, the packing assembly seal 78 may include a header ring (or a scraper ring) 96. For example, the packing assembly 68 may include one or more pressure rings 92 and a junk ring 94, and the packing assembly seal 78 may be positioned between the one or more pressure rings 92 and the junk ring 94, for example, as shown in FIGS. 2 and 3. Other relative orders are contemplated.

In some embodiments, the lantern ring 86 may include one or more metallic materials, such as bronze, aluminum, or brass, and/or other materials having similar characteristics, such as, for example, thermoplastics, polyamides (e.g., high performance engineering plastics, such as polyether ether ketone (PEEK)), and/or synthetic polymer alloys, such as ORKOT (an advanced reinforced medium weave polymer), and/or other composite bearing materials. In some embodiments, the lube seal 88 may include one or more of an O-ring seal, natural rubber, synthetic rubber, polymeric material, nitriles, fluorocarbon resins, or silicone resins. In some embodiments, the adaptor ring 90 may include one or more metallic materials, such as bronze, aluminum, or brass, and/or other materials having similar characteristics, such as, for example, thermoplastics, polyamides (e.g., high performance engineering plastics, such as polyether ether ketone (PEEK)), and/or synthetic polymer alloys, such as ORKOT (an advanced reinforced medium weave polymer), and/or other composite bearing materials. In some embodiments, the one or more pressure rings 92 may include one or more of fabric, composite, nitrile rubber (HNBR), polytetrafluoroethylene (PTFE), thermoplastic polyurethane (TPU), or RESILON. In some embodiments, the junk ring 94 may include one or more one or more metallic materials, such as steel, brass, bronze, or aluminum, composites, and/or other materials having similar characteristics, such as, for example, thermoplastics, polyamides (e.g., high performance engineering plastics, such as polyether ether ketone (PEEK)), and/or synthetic polymer alloys, such as ORKOT (an advanced reinforced medium weave polymer), and/or other composite bearing materials. Other materials for one or more of the rings are contemplated.

In some embodiments, the packing assembly seal 78 may include a header ring 96 (and/or a scraper ring), and the packing assembly 68 may include the lantern ring 86, the lube seal 88, the adaptor ring 90, one or more pressure rings 92, and the junk ring 94, for example, as shown in FIGS. 2 and 3. For example, the one of the header ring 96 (and/or a scraper ring) may be positioned between the junk ring 94 and the one or more pressure rings 92, the adaptor ring 90 may be positioned between the one or more pressure rings 92 and the lantern ring 86, and/or the lube seal 88 may be received in a groove 98 of the lantern ring 86 (FIG. 3).

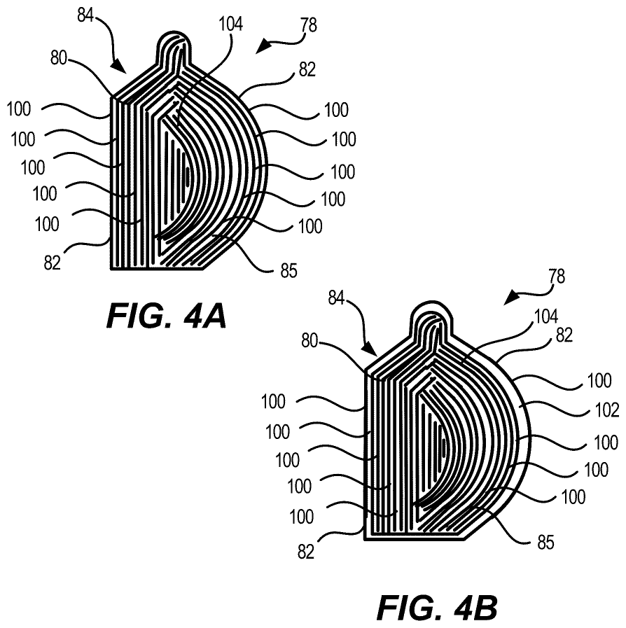

FIGS. 4A and 4B are schematic cross-section views of example packing assembly seals 78, according to embodiments of the disclosure. In some embodiments, the metal mesh(es) 85 may include a plurality of layers of the metal mesh 85 (see, e.g., FIGS. 4A and 4B). In some embodiments, the metal mesh 85 may include the plurality of layers 100 of the metal mesh 85 compressed and/or molded to form the annular seal body 80. In some embodiments, the metal mesh(es) 85 may be woven, and the size of the openings of the metal mesh 85 may be tailored to, for example, the use of the packing assembly seal 78, such as the type of fluid and/or particles/solids in the fluid. In some embodiments, the metal mesh 85 may include one or more of aluminum, aluminum alloy, brass, brass alloy, bronze, bronze alloy, silver, silver alloy, copper, copper alloy, steel, or steel alloy. Other metallic materials and/or metallic-like materials are contemplated.

In some embodiments, the packing assembly seal 78 may further include a non-metal mesh 102 including one or more of a non-woven non-metal mesh, a woven non-metal mesh, a woven non-metal fabric, or a non-woven non-metal fabric. For example, the non-metal mesh 102 may replace or supplement one or more of the metal meshes 85 (see, e.g., FIG. 4B).

In some embodiments, the annular seal body 80 further may include an elastomeric material. For example, the elastomeric material may include one or more of polymers, thermoplastic polymers, thermosetting polymers, elastomeric polymers, elastomers, thermoplastics, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), or RESILON, or polyurethane.

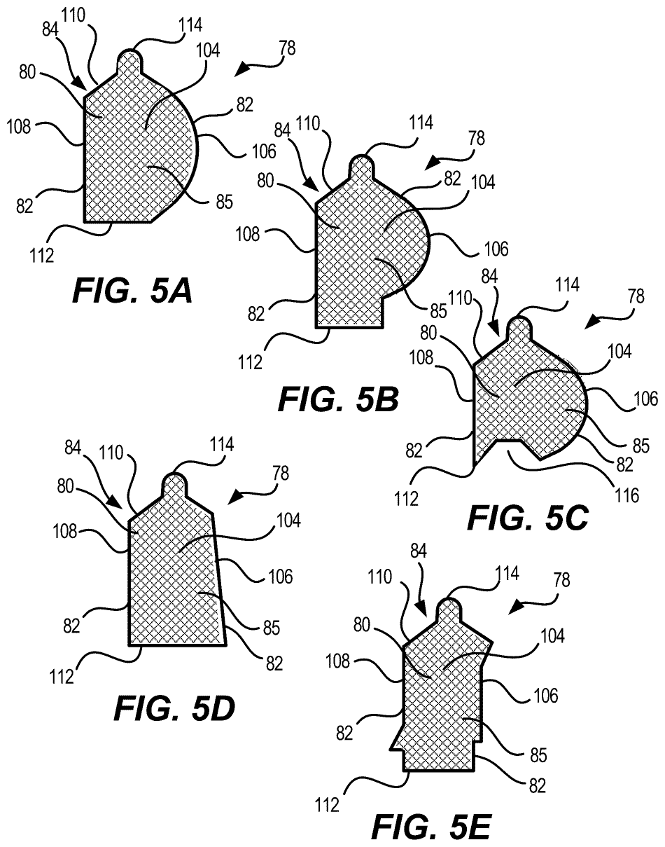

FIGS. 5A, 5B, 5C, 5D, and 5E are schematic cross-section views of example packing assembly seals 78 having respective seal cross-sections 84, according to embodiments of the disclosure. As shown in FIGS. 5A-5E, the annular seal body 80 may have different seal cross-sections 84. In some embodiments, the seal cross-sections 84 may include one or more of (a) a radially inward facing surface 106, (b) a radially outward facing surface 108 substantially opposite the radially inward facing surface 106, (c) a first axial end surface 110, or (d) a second axial end surface 112 substantially opposite the first axial end surface 110. In some embodiments, the radially inward facing surface 106 may include a substantially convex portion (see, e.g., FIGS. 5A-5C). In some embodiments, the radially outward facing surface 108 may include a substantially planar portion (see, e.g., FIGS. 5A-5E). In some embodiments, the first axial end surface 110 may at least partially define a protrusion 114 (see, e.g., FIGS. 5A-5E). In some embodiments, the second axial end surface 112 may at least partially define a recess 116 (see, e.g., FIG. 5C). As shown in FIGS. 5A-5E, various seal cross-section 84 shapes are contemplated.

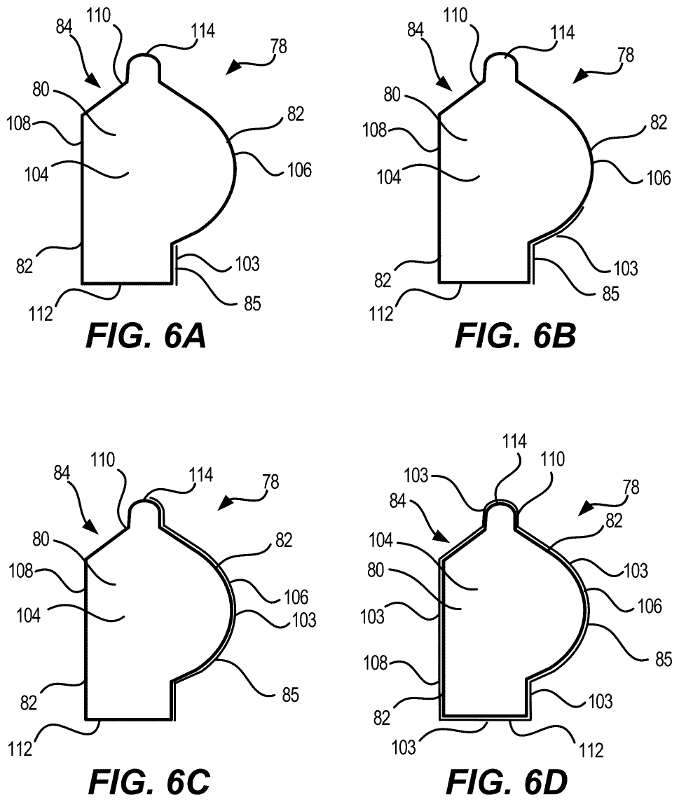

FIGS. 6A, 6B, 6C, and 6D are schematic cross-section views of example packing assembly seals 78, including respective example partial metal mesh covers 103 and example substantially complete metal mesh covers 103 (e.g., FIG. 6D), according to embodiments of the disclosure. In some embodiments, the elastomeric material may form a core 104 of the annular seal body 80, and the metal mesh 85 may at least partially cover the core 104, for example, as shown in FIGS. 6A, 6B, 6C, and 6D. In some embodiments, the metal mesh 85 may substantially and/or fully enclose the core 104, for example, as shown in FIG. 6D.

As shown in FIGS. 6A-6D, in some embodiments, for example, the metal mesh 85 may at least partially cover one or more of the radially inward facing surface 106 (see, e.g., FIGS. 6A-6D), the radially outward facing surface 108 (see, e.g., FIG. 6D), the first axial end surface 110 (see, e.g., FIGS. 6C and 6D), or the second axial end surface 112 (see, e.g., FIG. 6D). Other covering configurations are contemplated.

In some embodiments, the metal mesh 85 may be substantially impregnated with the elastomeric material (e.g., binder). For example, one or more of the metal mesh 85 layers 100 may be coated with and/or substantially encapsulated with elastomeric material. In some embodiments, the elastomeric material may be configured to adhere, secure, and/or fuse together one or more of the metal mesh layers 100, for example, such that the annular seal body 80 functions as an integrated single piece (e.g., as compared with, for example, layers that are separately removable from one another.) In some embodiments, the metal mesh(es) 85 may be at least partially embedded in the elastomeric material. In some embodiments, the metal mesh(es) 85 may be substantially homogeneously distributed in the elastomeric material, for example, throughout the core 104.

As noted herein, in some embodiments, the annular seal body 80 further may include a non-metal mesh 102 (see, e.g., FIG. 4B) including one or more of a non-woven non-metal mesh, a woven non-metal mesh, a woven non-metal fabric, or a non-woven non-metal fabric. The non-metal mesh 102 may supplement (or replace) one or more of the metal meshes 85. At least some such embodiments further may include an elastomeric material.

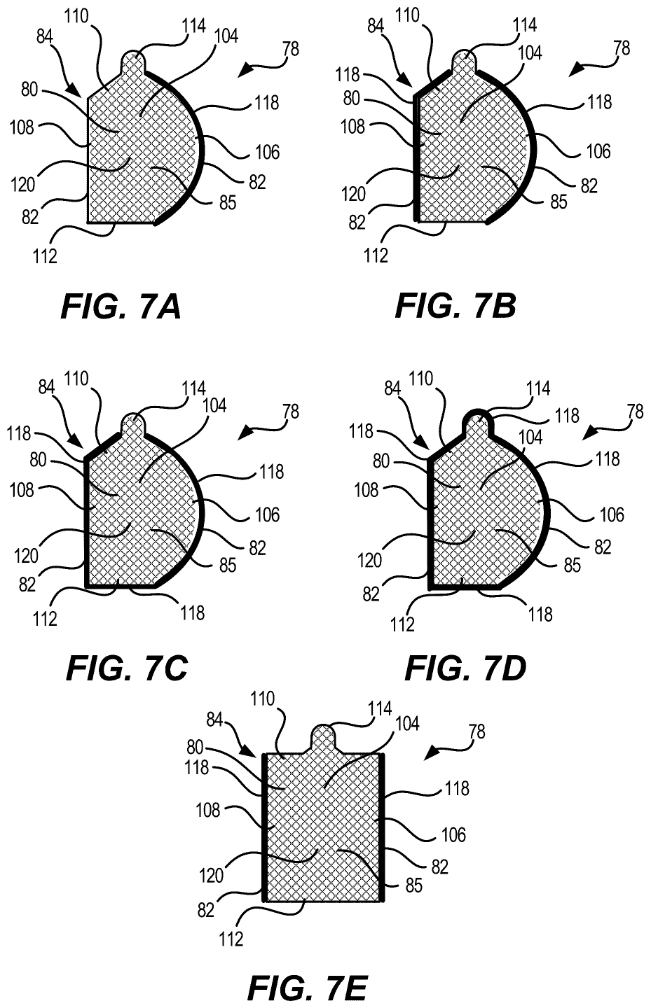

FIGS. 7A, 7B, 7C, 7D, and 7E are schematic cross-section views of examples of packing assembly seals 78, including metal mesh(es) 85 having example partial thermally conductive layers 118 (e.g., FIGS. 7A-7C and 7E) and a substantially complete thermally conductive layer 118 (e.g., FIG. 7D), according to embodiments of the disclosure. As shown in FIGS. 7A-7E, for example, in some embodiments, the metal mesh (or meshes) 85 may at least partially form the core 104 of the annular seal body 80. In some embodiments, the core 104 may further include binder 120 at least partially embedded in the metal mesh(es) 85 of the core 85. The binder 120 may include, for example, any material that secures the metal mesh(es) 85 together to form a unitary structure, such as, for example, any of the polymeric materials and/or elastomeric materials described herein (and/or other similar material types). In some embodiments consistent with FIGS. 7A-7E, the core 104 may not include any binder, but rather, may include solely the metal mesh(es) 85 formed into the core 104. In some embodiments, the core 85 may be formed, for example, via compression and/or molding the metal mesh(es) 85 to form the metal mesh(es) 85 into to the annular seal body 80.

As shown in FIGS. 7A-7E, the packing assembly seal 78 further may include the thermally conductive layer 118, which may at least partially cover the core 104, thereby to enhance the thermal conductivity of the packing assembly seal 78. For example, as shown in FIGS. 7A-7E, the seal cross-section 84 may include one or more of: (a) a radially inward facing surface 106; (b) a radially outward facing surface 108 substantially opposite the radially inward facing surface 106; (c) a first axial end surface 110; or (d) a second axial end surface 112 substantially opposite the first axial end surface 110. As shown, in some embodiments, (a) the radially inward facing surface 106 may include a substantially convex portion; (b) the radially outward facing surface 108 may include a substantially planar portion; (c) the first axial end surface 110 may at least partially define a protrusion 114; and/or (d) the second axial end surface 112 may at least partially define a recess 116 (see, e.g., FIG. 5C). In some embodiments, for example, as shown in FIG. 7E, the core 104 may have a substantially polygonal shape (e.g., a substantially rectangular shape), for example, without significant convex portions, concave portions, and/or recesses. Although the example shown in FIG. 7E includes an example protrusion 114, cores substantially devoid of protrusions are contemplated. Other cross-sectional shapes are contemplated for the core 104, such as, for example, shapes at least similar to those shown in FIGS. 5B-5E, as well as others.

As shown in FIGS. 7A-7E, in some embodiments, the thermally conductive layer 118 may at least partially cover one or more of the radially inward facing surface 106 (see, e.g., FIGS. 7A-7E), the radially outward facing surface 108 (see, e.g., FIGS. 7B-7E), the first axial end surface 110 (see, e.g., FIGS. 7B-7D), and/or the second axial end surface 112 (see, e.g., FIGS. 7C and 7D). For example, in some embodiments, the thermally conductive layer 118 may at least partially cover the radially inward facing surface 106 and may at least partially cover the radially outward facing surface 108, for example, as shown in FIGS. 7B-7E. Configurations consistent with such a construction may enhance transfer of heat from the packing assembly seal 78 to (e.g., directly to), for example, the fluid end housing 18, the packing sleeve 74, and/or the plunger 22, depending on, for example, the configuration of the pump 10 (see, e.g., FIG. 1).

In some embodiments, the core 104 and the thermally conductive layer 118 may be compressed and/or molded together to form a single-piece integrated annular seal body 80. For example, the core 104 may include metal mesh(es) 85 and binder 120, and the core 104 and the thermally conductive layer(s) 118 may be placed in a mold and formed into an annular seal body 80 of the packing assembly seal 78 having a desired cross-sectional size, a desired cross-sectional shape, and/or desired location(s) of the thermally conductive layer(s) 118. Other methods of forming packing assembly seals 78 consistent with the example packing assembly seals 78 shown in FIGS. 7A-7E are contemplated.

The thermally conductive layer(s) 118 may, in at least some embodiments, include one or more metallic layers, and the one or more metallic layers may include, for example, steel, stainless steel, aluminum, copper, iron, nickel, brass, and/or tungsten, as well as alloys of one or more of those materials. Other materials (and combinations of materials) having similar thermal conductivities are contemplated for the thermally conductive layer(s) 118.

In some embodiments, the metal mesh 85 may be configured to enhance thermal conductivity between the packing assembly seal 78 (e.g., the header ring 96 (and/or scraper ring)) and one or more of the packing sleeve 74, the lantern ring 86, the junk ring 94, the fluid end block 18, or the plunger 22, thereby to transfer heat from the packing assembly seal 78 to the one or more of the packing sleeve 74, the lantern ring 86, the junk ring 94, the fluid end block 18, or the plunger 22. Enhanced heat transfer to other components of the pump 10 is contemplated.

A method for enhancing a seal between a surface of a first component of a pump and a surface of a second component of the pump, may include positioning a seal (e.g., a packing assembly seal 78) between the surface of the first component and the surface of the second component. The seal may have an annular seal body 80 including a metal mesh 85. The method further may include transferring heat, via the metal mesh 85, from the annular seal body 80 to one or more of the first component or the second component during operation of the pump, thereby to reduce a temperature of the seal and extend a service life of the seal.

In some embodiments of the method, the metal mesh 85 may include one or more of a woven metal mesh, a non-woven metal mesh, a metal woven fabric, or a metal non-woven fabric. In some embodiments of the method, the metal mesh 85 may include a plurality of layers 100 of the metal mesh 85. For example, the metal mesh 85 may include the plurality of layers 100 of the metal mesh 85 compressed into the annular seal body 80 (e.g., thereby to form the shape of the annular seal body 80). In some embodiments of the method, the annular seal body 80 further may include a non-metal mesh 102, which may include one or more of a non-woven non-metal mesh, a woven non-metal mesh, a woven non-metal fabric, or a non-woven non-metal fabric.

In some embodiments of the method, the metal mesh 85 may include one or more of aluminum, aluminum alloy, brass, brass alloy, bronze, bronze alloy, silver, silver alloy, copper, copper alloy, steel, or steel alloy. Other metallic materials are contemplated.

In some embodiments of the method, the annular seal body 80 further may include an elastomeric material. The elastomeric material may include one or more of polymers, thermoplastic polymers, thermosetting polymers, elastomeric polymers, elastomers, thermoplastics, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), or RESILON, or polyurethane. Other elastomeric materials are contemplated.

In some embodiments of the method, the elastomeric material may form a core 104 of the annular seal body 80, and the metal mesh 85 may at least partially cover the core 104. In some embodiments of the method, the metal mesh 85 may substantially fully enclose the core 104.

In some embodiments of the method, the seal cross-section 84 may include (a) a radially inward facing surface 106, (b) a radially outward facing surface 108 substantially opposite the radially inward facing surface 106, (c) a first axial end surface 110, and (d) a second axial end surface 112 substantially opposite the first axial end surface 110. In some embodiments of the method, one or more of: (a) the radially inward facing surface 106 may include a substantially convex portion; (b) the radially outward facing surface 108 may include a substantially planar portion; (c) the first axial end surface 110 may at least partially define a protrusion 114; or (d) the second axial end surface 112 may at least partially define a recess 116. In at least some such embodiments, the metal mesh 85 may at least partially cover one or more of the radially inward facing surface 106, the radially outward facing surface 108, the first axial end surface 110, or the second axial end surface 112.

In some embodiments of the method, the metal mesh 85 may be substantially impregnated with the elastomeric material. In some embodiments of the method, the metal mesh 85 may be at least partially embedded in the elastomeric material. In some embodiments of the method, the metal mesh 85 may be substantially homogeneously distributed in the elastomeric material.

In some embodiments of the method, the annular seal body 80 further may include a non-metal mesh 102. The non-metal mesh 102 may include one or more of a non-woven non-metal mesh, a woven non-metal mesh, a woven non-metal fabric, or a non-woven non-metal fabric. In at least some such embodiments, the annular seal body may further include an elastomeric material, for example, as described herein.

In some embodiments of the method, the packing assembly seals 78 may be provided with metal mesh(es) 85 having partial thermally conductive layers 118 or substantially complete thermally conductive layers 118 (e.g., FIG. 7D. For example, in some embodiments, the metal mesh (or meshes) 85 may at least partially form the core 104 of the annular seal body 80. In some embodiments, the core 104 may further include binder 120 at least partially embedded in the metal mesh(es) 85 of the core 104. The binder 120 may include, for example, any material that secures the metal mesh(es) 85 together to form a unitary structure, such as, for example, any of the polymeric materials and/or elastomeric materials described herein (and/or other similar material types). In some embodiments, the core 104 may not include any binder, but rather, may include solely the metal mesh(es) 85 formed into the core 104. In some embodiments, the core 104 may be formed, for example, via compression and/or molding the metal mesh(es) 85 to form the metal mesh(es) 85 into to the annular seal body 80.

In some embodiments of the method, the transferring of the heat may include providing the thermally conductive layer(s) 118, which may at least partially cover the core 104, thereby to enhance the thermal conductivity of the packing assembly seal 78. For example, the seal cross-section 84, as shown in FIGS. 7A-7E, may include one or more of: (a) a radially inward facing surface 106; (b) a radially outward facing surface 108 substantially opposite the radially inward facing surface 106; (c) a first axial end surface 110; or (d) a second axial end surface 112 substantially opposite the first axial end surface 110. In some embodiments, (a) the radially inward facing surface 106 may include a substantially convex portion; (b) the radially outward facing surface 108 may include a substantially planar portion; (c) the first axial end surface 110 may at least partially define a protrusion 114; and/or (d) the second axial end surface 112 may at least partially define a recess 116 (see, e.g., FIG. 5C). In some embodiments, for example, as shown in FIG. 7E, the core 104 may have a substantially polygonal shape (e.g., a substantially rectangular shape), for example, without significant convex portions, significant concave portions, and/or significant recesses. Although the example shown in FIG. 7E includes an example protrusion 114, cores substantially devoid of protrusions are contemplated. Other cross-sectional shapes are contemplated, such as, for example, shapes at least similar to those shown in FIGS. 5B-5E.

In some embodiments of the method, the thermally conductive layer(s) 118 may at least partially cover one or more of the radially inward facing surface 106 (see, e.g., FIGS. 7A-7E), the radially outward facing surface 108 (see, e.g., FIGS. 7B-7E), the first axial end surface 110 (see, e.g., FIGS. 7B-7D), and/or the second axial end surface 112 (see, e.g., FIGS. 7C and 7D). For example, in some embodiments, the thermally conductive layer(s) 118 may at least partially cover the radially inward facing surface 106 and may at least partially cover the radially outward facing surface 108, for example, as shown in FIGS. 7B-7E. Methods consistent with such a construction may enhance transfer of heat from the packing assembly seal 78 to (e.g., directly to), for example, the fluid end housing 18, the packing sleeve 74, and/or the plunger 22, depending on, for example, the configuration of the pump 10 (see, e.g., FIG. 1).

In some embodiments of the method, the core 104 and the thermally conductive layer(s) 118 may be compressed and/or molded together to form a single-piece integrated annular seal body 80. For example, the core 104 may include metal mesh(es) 85 and binder 120, and the core 104 and the thermally conductive layer(s) 118 may be placed in a mold and formed into an annular seal body 80 of the packing assembly seal 78 having a desired cross-sectional size, a desired cross-sectional shape, and/or desired location(s) of the thermally conductive layer(s) 118. Other methods of forming packing assembly seals 78 are contemplated.

In some embodiments of the method, the thermally conductive layer(s) 118 may include one or more metallic layers, and the one or more metallic layers may include, for example, steel, stainless steel, aluminum, copper, iron, nickel, brass, and/or tungsten, as well as alloys of one or more of those materials. Other materials (and combinations of materials) having similar thermal conductivities are contemplated for the thermally conductive layer(s) 118.

In some embodiments of the method, the positioning of the seal (e.g., the packing assembly seal 78, may include positioning the seal between a stationary component of the pump and one of (a) a reciprocating component of the pump or (b) a rotating component of the pump. For example, in some embodiments of the method, the seal may include one or more of a header ring 96, a pressure ring 92, a scraper ring, or a face seal. For example, the seal may include a packing assembly seal 78. In some embodiments of the method, the positioning of the seal may include positioning the seal between a packing sleeve 74 and a plunger 22.

In some embodiments of the method, the transferring of heat, via the metal mesh 85, from the annular seal body 80 to one or more of the first component or the second component, may include transferring heat from the seal to one or more of a packing sleeve 74, a lantern ring 86, a junk ring 94, a fluid end block 18, or a plunger 22.

In some embodiments, a method for enhancing a seal between a surface of a first component of a pump and a surface of a second component of the pump, may include forming an annular seal body 80 having a seal body surface 82 and a seal cross-section 84 at least partially defined by the seal body surface 82. In some embodiments of the method, the annular seal body 80 may include a metal mesh 85, thereby to enhance thermal conductivity between the seal and one or more of the first component or the second component, so as to transfer heat from the seal to one or more of the first component or the second component, thereby to reduce a temperature of the seal and extend a service life of the seal.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

This application claims priority to, and the benefit of U.S. Provisional Application No. 63/694,532, filed Sep. 13, 2024, titled “SYSTEMS, ASSEMBLIES, APPARATUSES, AND METHODS PROVIDING ENHANCED FLUID SEAL FOR HIGH-POWER PUMPS,” the disclosure of which is incorporated herein by reference in its entirety.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further may be made thereto without departing from the spirit and scope of the present disclosure as set forth in the appended claims.

What is claimed is:

1. A fluid end for a high pressure pump, the fluid end comprising:
a fluid end block at least partially defining a fluid end bore;
a packing recess associated with the fluid end bore, the packing recess at least partially defining a packing recess bore; and
a packing assembly at least partially received in the packing recess bore, the packing assembly positioned to enhance a fluid seal between a surface of a first component of the high pressure pump and a surface of a second component of the high pressure pump, the packing assembly comprising:
a packing assembly seal comprising:
an annular seal body having a seal body surface and a seal cross-section at least partially defined by the seal body surface, the annular seal body comprising a metal mesh, thereby to enhance thermal conductivity between the packing assembly seal and one or more of the first component or the second component, so as to transfer heat from the packing assembly seal to one or more of the first component or the second component, thereby to reduce a temperature of the packing assembly seal and extend a service life of the packing assembly seal; and
one or more of:
(a) a lantern ring;
(b) a lube seal;
(c) an adaptor ring;
(d) a pressure ring; or
(e) a junk ring.

2. The fluid end of claim 1, further comprising a packing sleeve at least partially defining the packing recess, the packing sleeve being one of: (a) at least partially received in the fluid end bore, or (b) at least partially received in a packing housing attached to the fluid end block.

3. The fluid end of claim 1, wherein one or more of:
(a) the packing assembly includes the lantern ring, and the lantern ring comprises one or more of bronze, aluminum, or brass;
(b) the packing assembly includes the lube seal, and the lube seal comprises one or more of an O-ring seal, natural rubber, synthetic rubber, polymeric material, nitriles, fluorocarbon resins, or silicone resins;
(c) the packing assembly includes the adaptor ring, and the adaptor ring comprises one or more of bronze, aluminum, or brass;
(d) the packing assembly includes the pressure ring, and the pressure ring comprises one or more of fabric, composite, nitrile rubber (HNBR), polytetrafluoroethylene (PTFE), thermoplastic polyurethane (TPU), or RESILON; or
(e) the packing assembly includes the junk ring, and the junk ring comprises one or more of composite, steel, brass, bronze, aluminum, or polyether ether ketone (PEEK).

4. The fluid end of claim 1, wherein one or more of:
(a) the metal mesh comprises one or more of a woven metal mesh, a non-woven metal mesh, a metal woven fabric, or a metal non-woven fabric;
(b) the metal mesh comprises a plurality of layers of the metal mesh, the plurality of layers of the metal mesh compressed into the annular seal body;
(c) the metal mesh comprises one or more of aluminum, aluminum alloy, brass, brass alloy, bronze, bronze alloy, silver, silver alloy, copper, copper alloy, steel, or steel alloy; or
(d) the metal mesh is configured to enhance thermal conductivity between the packing assembly seal and one or more of a packing sleeve, a lantern ring, a junk ring, a fluid end block, or a plunger, thereby to transfer heat from the packing assembly seal to the one or more of the packing sleeve, the lantern ring, the junk ring, the fluid end block, or the plunger.

5. The fluid end of claim 1, further comprising a non-metal mesh comprising one or more of a non-woven non-metal mesh, a woven non-metal mesh, a woven non-metal fabric, or a non-woven non-metal fabric.

6. The fluid end of claim 1, wherein the annular seal body further comprises an elastomeric material, and one or more of:
(a) the elastomeric material comprises one or more of polymers, thermoplastic polymers, thermosetting polymers, elastomeric polymers, elastomers, thermoplastics, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), or RESILON, or polyurethane; or
(b) the elastomeric material forms a core of the annular seal body, and the metal mesh at least partially covers the core.

7. The fluid end of claim 6, wherein:
(a) the seal cross-section comprises:
(1) a radially inward facing surface;
(2) a radially outward facing surface substantially opposite the radially inward facing surface;
(3) a first axial end surface; and
(4) a second axial end surface substantially opposite the first axial end surface; and
(b) one or more of:
(1) the radially inward facing surface includes a substantially convex portion;
(2) the radially outward facing surface includes a substantially planar portion;
(3) the first axial end surface at least partially defines a protrusion;
(4) the second axial end surface at least partially defines a recess;
(5) the metal mesh at least partially covers one or more of the radially inward facing surface, the radially outward facing surface, the first axial end surface, or the second axial end surface;
(6) the metal mesh is impregnated with the elastomeric material; or
(7) the metal mesh is at least partially embedded in the elastomeric material.

8. The fluid end of claim 1, wherein:
(a) the metal mesh at least partially forms a core of the annular seal body, and the seal further comprises a thermally conductive layer at least partially covering the core, thereby to enhance the thermal conductivity of the seal; and
(b) one or more of:
(1) the core further comprises binder at least partially embedded in the metal mesh;
(2) the seal cross-section comprises:
(i) a radially inward facing surface,
(ii) a radially outward facing surface substantially opposite the radially inward facing surface,
(iii) a first axial end surface,
(iv) a second axial end surface substantially opposite the first axial end surface,
(v) the radially inward facing surface includes a substantially convex portion,
(vi) the radially outward facing surface includes a substantially planar portion,
(vii) the first axial end surface at least partially defines a protrusion, or
(viii) the second axial end surface at least partially defines a recess;
(3) the thermally conductive layer at least partially covers one or more of the radially inward facing surface, the radially outward facing surface, the first axial end surface, or the second axial end surface;
(4) the thermally conductive layer at least partially covers the radially inward facing surface and at least partially covers the radially outward facing surface;
(5) the core and the thermally conductive layer are molded together to form a single-piece integrated annular seal body; or
(6) the thermally conductive layer comprises one or more metallic layers, and the one or more metallic layers comprise one or more of steel, stainless steel, aluminum, copper, iron, nickel, brass, or tungsten.

9. The fluid end of claim 1, further comprising:
a non-metal mesh comprising one or more of a non-woven non-metal mesh, a woven non-metal mesh, a woven non-metal fabric, or a non-woven non-metal fabric; and
an elastomeric material.

10. The fluid end of claim 1, wherein one or more of:
(a) the first component of the high pressure pump comprises a packing sleeve, and the second component of the high pressure pump comprises a plunger; or
(b) the metal mesh is configured to enhance thermal conductivity between the packing assembly seal and one or more of a packing sleeve, a lantern ring, a junk ring, a fluid end block, or a plunger, thereby to transfer heat from the packing assembly seal to the one or more of the packing sleeve, the lantern ring, the junk ring, the fluid end block, or the plunger.

11. A packing assembly to enhance a fluid seal between a surface of a first component of a high pressure pump and a surface of a second component of the high pressure pump, the packing assembly comprising:
a packing assembly seal comprising:
an annular seal body having a seal body surface and a seal cross-section at least partially defined by the seal body surface, the annular seal body comprising a metal mesh, thereby to enhance thermal conductivity between the packing assembly seal and one or more of the first component or the second component, so as to transfer heat from the packing assembly seal to one or more of the first component or the second component, thereby to reduce a temperature of the packing assembly seal and extend a service life of the packing assembly seal; and
one or more of:
(a) a lantern ring;
(b) a lube seal;
(c) an adaptor ring;
(d) a pressure ring; or
(e) a junk ring.

12. The packing assembly of claim 11, wherein:
(a) the packing assembly seal comprises one of a header ring or a scraper ring, and the packing assembly comprises:
(1) a lantern ring;
(2) a lube seal;
(3) an adaptor ring;
(4) a pressure ring; and
(5) a junk ring; and
(b) one or more of:
(1) the one of the header ring or the scraper ring is between the junk ring and the pressure ring,
(2) the adaptor ring is between the pressure ring and the lantern ring, or
(3) the lube seal is received in a groove of the lantern ring.

13. The packing assembly of claim 11, wherein one or more of:
(a) the metal mesh comprises one or more of a woven metal mesh, a non-woven metal mesh, a metal woven fabric, or a metal non-woven fabric;
(b) the metal mesh comprises a plurality of layers of the metal mesh;
(c) the metal mesh comprises the plurality of layers of the metal mesh compressed into the annular seal body;
(d) the metal mesh comprises one or more of aluminum, aluminum alloy, brass, brass alloy, bronze, bronze alloy, silver, silver alloy, copper, copper alloy, steel, or steel alloy; or
(e) the metal mesh at least partially forms a core of the annular seal body, and the seal further comprises a thermally conductive layer at least partially covering the core, thereby to enhance the thermal conductivity of the seal.

14. The packing assembly of claim 11, further comprising a non-metal mesh comprising one or more of a non-woven non-metal mesh, a woven non-metal mesh, a woven non-metal fabric, or a non-woven non-metal fabric.

15. The packing assembly of claim 11, wherein the annular seal body further comprises an elastomeric material, and one or more of:
(a) the elastomeric material comprises one or more of polymers, thermoplastic polymers, thermosetting polymers, elastomeric polymers, elastomers, thermoplastics, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), or RESILON, or polyurethane;
(b) the elastomeric material forms a core of the annular seal body, and the metal mesh at least partially covers the core; or
(c) the metal mesh fully encloses the core.

16. The packing assembly of claim 11, wherein:
(a) the annular seal body further comprises an elastomeric material, the elastomeric material forms a core of the annular seal body, and the metal mesh at least partially covers the core;
(b) the seal cross-section comprises:
(1) a radially inward facing surface,
(2) a radially outward facing surface substantially opposite the radially inward facing surface,
(3) a first axial end surface, and
(4) a second axial end surface substantially opposite the first axial end surface; and
(c) one or more of:
(1) the radially inward facing surface includes a substantially convex portion,
(2) the radially outward facing surface includes a substantially planar portion,
(3) the first axial end surface at least partially defines a protrusion,
(4) the second axial end surface at least partially defines a recess,
(5) the metal mesh at least partially covers one or more of the radially inward facing surface, the radially outward facing surface, the first axial end surface, or the second axial end surface,
(6) the metal mesh is impregnated with the elastomeric material,
(7) the metal mesh is at least partially embedded in the elastomeric material, or
(8) the metal mesh is substantially homogeneously distributed in the elastomeric material.

17. The packing assembly of claim 11, wherein:
(a) the metal mesh at least partially forms a core of the annular seal body, and the seal further comprises a thermally conductive layer at least partially covering the core, thereby to enhance the thermal conductivity of the seal; and
(b) one or more of:
(1) the seal cross-section comprises:
(i) a radially inward facing surface,
(ii) a radially outward facing surface substantially opposite the radially inward facing surface,
(iii) a first axial end surface, and
(iv) a second axial end surface substantially opposite the first axial end surface;
(2) one or more of:
(i) the radially inward facing surface includes a substantially convex portion,
(ii) the radially outward facing surface includes a substantially planar portion,
(iii) the first axial end surface at least partially defines a protrusion, or
(iv) the second axial end surface at least partially defines a recess;
(3) the thermally conductive layer at least partially covers one or more of the radially inward facing surface, the radially outward facing surface, the first axial end surface, or the second axial end surface;
(4) the thermally conductive layer at least partially covers the radially inward facing surface and at least partially covers the radially outward facing surface;
(5) the core and the thermally conductive layer are molded together to form a single-piece integrated annular seal body; or
(6) the thermally conductive layer comprises one or more metallic layers, and the one or more metallic layers comprise one or more of steel, stainless steel, aluminum, copper, iron, nickel, brass, or tungsten.

18. The packing assembly of claim 11, further comprising:
a non-metal mesh comprising one or more of a non-woven non-metal mesh, a woven non-metal mesh, a woven non-metal fabric, or a non-woven non-metal fabric; and
an elastomeric material.

19. The packing assembly of claim 11, wherein one or more of:
(a) the first component of the pump comprises a packing sleeve, and the second component of the pump comprises a plunger; or
(b) the metal mesh is configured to enhance thermal conductivity between the packing assembly seal and one or more of a packing sleeve, a lantern ring, a junk ring, a fluid end block, or a plunger, thereby to transfer heat from the packing assembly seal to the one or more of the packing sleeve, the lantern ring, the junk ring, the fluid end block, or the plunger.

20. A seal to enhance a fluid seal between a surface of a first component of a high pressure pump and a surface of a second component of the high pressure pump, the seal comprising:
an annular seal body having a seal body surface and a seal cross-section at least partially defined by the seal body surface, the annular seal body comprising a metal mesh, thereby to enhance thermal conductivity between the seal and one or more of the first component or the second component, so as to transfer heat from the seal to one or more of the first component or the second component, thereby to reduce a temperature of the seal and extend a service life of the seal.

21. The seal of claim 20, wherein one or more of:
(a) the metal mesh comprises one or more of a woven metal mesh, a non-woven metal mesh, a metal woven fabric, or a metal non-woven fabric;
(b) the metal mesh comprises a plurality of layers of the metal mesh;
(c) the metal mesh comprises the plurality of layers of the metal mesh compressed into the annular seal body;
(d) the metal mesh comprises one or more of aluminum, aluminum alloy, brass, brass alloy, bronze, bronze alloy, silver, silver alloy, copper, copper alloy, steel, or steel alloy; or
(e) the metal mesh is positioned to enhance thermal conductivity between the seal and one or more of a packing sleeve, a lantern ring, a junk ring, a fluid end block, or a plunger, thereby to transfer heat from the seal to the one or more of the packing sleeve, the lantern ring, the junk ring, the fluid end block, or the plunger.

22. The seal of claim 20, further comprising a non-metal mesh comprising one or more of a non-woven non-metal mesh, a woven non-metal mesh, a woven non-metal fabric, or a non-woven non-metal fabric.

23. The seal of claim 20, wherein:
(a) the annular seal body further comprises an elastomeric material; and
(b) one or more of:
the elastomeric material comprises one or more of polymers, thermoplastic polymers, thermosetting polymers, elastomeric polymers, elastomers, thermoplastics, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), or RESILON, or polyurethane;
(2) the elastomeric material forms a core of the annular seal body, and the metal mesh at least partially covers the core;
(3) the metal mesh is impregnated with the elastomeric material;
(4) the metal mesh is at least partially embedded in the elastomeric material;
(5) the metal mesh is substantially homogeneously distributed in the elastomeric material;
(6) the metal mesh at least partially forms a core of the annular seal body, and the seal further comprises a thermally conductive layer at least partially covering the core, thereby to enhance the thermal conductivity of the seal; or
(7) the core further comprises binder at least partially embedded in the metal mesh.

24. The seal of claim 20, wherein:
(a) the annular seal body further comprises an elastomeric material, the elastomeric material forming a core of the annular seal body, and the metal mesh at least partially covering the core;
(b) the seal cross-section comprises:
(1) a radially inward facing surface,
(2) a radially outward facing surface substantially opposite the radially inward facing surface,
(3) a first axial end surface, and
(4) a second axial end surface substantially opposite the first axial end surface; and
(c) one or more of:
(1) the radially inward facing surface includes a substantially convex portion;
(2) the radially outward facing surface includes a substantially planar portion;
(3) the first axial end surface at least partially defines a protrusion; or
(4) the second axial end surface at least partially defines a recess.

25. The seal of claim 24, wherein the metal mesh at least partially covers one or more of the radially inward facing surface, the radially outward facing surface, the first axial end surface, or the second axial end surface.

26. The seal of claim 20, wherein the metal mesh at least partially forms a core of the annular seal body, and the seal further comprises a thermally conductive layer at least partially covering the core, thereby to enhance the thermal conductivity of the seal.

27. The seal of claim 20, wherein one or more of:
(a) the first component of the high pressure pump comprises a stationary component, and the second component of the high pressure pump comprises one of a reciprocating component or a rotating component;
(b) the seal comprises one or more of a header ring, a pressure ring, a scraper ring, or a face seal; or
(c) the seal comprises a packing assembly seal, the first component of the high-pressure reciprocating pump comprising a packing sleeve, and the second component of the pump comprising a plunger.

28. A method of operating high pressure pump, the method comprising:
positioning a seal between a surface of a first component of the high pressure pump and a surface of a second component of the high pressure pump, the seal having an annular seal body including a metal mesh; and
transferring heat, via the metal mesh, from the annular seal body to one or more of the first component or the second component during operation of the high pressure pump, thereby to reduce a temperature of the seal and extend a service life of the seal.

29. The method of claim 28, wherein:
(a) the positioning of the seal comprises positioning the seal between a stationary component of the pump and one of (a) a reciprocating component of the pump or (b) a rotating component of the pump; and
(b) one or more of:
(1) the seal comprises one or more of a header ring, a pressure ring, a scraper ring, or a face seal; or
(2) the seal comprises a packing assembly seal, and the positioning of the seal comprises positioning the seal between a packing sleeve and a plunger.

30. The method of claim 28, wherein the transferring of heat, via the metal mesh, from the annular seal body to one or more of the first component or the second component comprises transferring heat from the seal to one or more of a packing sleeve, a lantern ring, a junk ring, a fluid end block, or a plunger.
